(19) United States
(12) Patent Application Publication
(10) Pub. No.: US 2018/0239640 A1
(43) Pub. Date: Aug. 23, 2018

(54) DISTRIBUTED DATA PROCESSING SYSTEM, AND DISTRIBUTED DATA PROCESSING METHOD

(71) Applicant: HITACHI, LTD., Tokyo (JP)

(72) Inventors: Izumi MIZUTANI, Tokyo (JP); Yoshiki MATSUURA, Tokyo (JP); Yu NAKATA, Tokyo (JP); Tatsuhiko MIYATA, Tokyo (JP)

(73) Assignee: HITACHI, LTD., Tokyo (JP)

(21) Appl. No.: 15/896,764

(22) Filed: Feb. 14, 2018

(30) Foreign Application Priority Data
Feb. 20, 2017 (JP) 2017-028996

(51) Int. Cl. G06F 9/48; G06F 9/50

(52) U.S. Cl. CPC G06F 9/4881; G06F 9/5016; G06F 9/5044; G06F 9/505

(57) ABSTRACT

A distributed data processing system configured to perform distributed processing of multiple data processing processes at multiple processors includes: a data storage configured to store data to be processed through the data processing processes; a data processing section configured to cause the data processing processes to be executed; and a scheduler configured to produce a data processing schedule as a data processing procedure of the data processing processes to be executed by the data processing section based on a data processing model obtained by modeling the data processing procedure to be executed by the data processing section. The data processing section causes the processors to execute the data processing processes in accordance with the data processing procedure set in the data processing schedule.

### CROSS-REFERENCE TO RELATED APPLICATION

This application claims priority pursuant to 35 U.S.C. § 119 from Japanese Patent Application No. 2017-28996, filed on Feb. 20, 2017, the entire disclosure of which is incorporated herein by reference.

### BACKGROUND

The present invention relates to a distributed data processing system, a distributed data processing method, and a distributed data processing program.

Since the era of IoT (Internet of Things), in which various sensor devices are coupled with the Internet, started following mobile network expansion due to the spread of smartphones, sensing has been performed where no sensor device had been installed, and accordingly, the types of sensing information have been diversified. As a result, the amount of data usable for analysis has been increasing, and the need for large-volume data analysis typified by artificial intelligence and machine learning has been increasing. The large-volume data analysis requires along time until a result is obtained, and thus it is desired to reduce an execution time by establishing a system capable of executing distributed data processing and operating a data analysis application in parallel in a distributed manner.

However, it is difficult for the developer of an analysis application to develop an analysis processing algorithm with parallelization of analysis processing also taken into consideration. This is because planning of appropriate parallelization processing requires expertise different from that for development of an application of itself. Thus, while the developer of an analysis application focuses on development of an analysis processing algorithm, parallelization processing is separately planned and executed in many cases.

For example, International Publication No. WO11/078162 related to parallelization processing of an analysis application discloses a scheduling device that produces an execution schedule of an application to be executed based on the data flow of the application and operates the application based on the produced schedule. This scheduling device enables efficient parallel distribution of the analysis application without requiring the developer of the analysis application to perform parallelization additionally.

### SUMMARY

However, the method disclosed in WO11/078162 performs scheduling focused on a timing when data referred to by an application at each processing is transferred to a memory in a server or a DB, and thus cannot perform scheduling focused on efficient execution of the application in the entire system.

In addition, the method disclosed in WO11/078162 does not consider the characteristics of data provided as an input at analysis processing, the characteristics of a computer that executes analysis processing, nor handling of data, reference to which is ended. Thus, it is difficult to perform optimum scheduling by using the method disclosed in WO11/078162.

The present invention is intended to solve the above-described and other problems. It is one purpose of the present invention to provide a distributed data processing system, a distributed data processing method, and a distributed data processing program that are capable of performing appropriate distributed scheduling in accordance with requirements at analysis application execution.

### Solution to Problem

An aspect of the present invention for achieving the above-described and other purposes is a distributed data processing system configured to cause a plurality of processors to perform distributed processing of a plurality of data processing processes. The distributed data processing system includes: a data storage configured to store data to be processed through the data processing processes; a data processing section configured to cause the data processing processes to be executed; and a scheduler configured to produce a data processing schedule as a data processing procedure of the data processing processes to be executed by the data processing section based on a data processing model obtained by modeling the data processing procedure to be executed by the data processing section. The data processing section causes the processors to execute the data processing processes in accordance with the data processing procedure set in the data processing schedule.

A distributed data processing system, a distributed data processing method, and a distributed data processing program according to the teachings herein enable distributed scheduling appropriate for needs at execution of an analysis application.

The details of one or more implementations of the subject matter described in the specification are set forth in the accompanying drawings and the description below. Other features, aspects, and advantages of the subject matter will become apparent from the description, the drawings, and the claims.

### BRIEF DESCRIPTION OF DRAWINGS

FIG. 1 is a diagram exemplarily illustrating a system configuration of a distributed data processing system a first embodiment of the present invention.

FIG. 2 is a diagram exemplarily illustrating the configuration of a scheduling server 101 according to the present embodiment.

FIG. 3 is a diagram exemplarily illustrating the configuration of a schedule calculation program 206 in the scheduling server 101.

FIG. 4 is a diagram exemplarily illustrating the configuration of data stored in a non-volatile storage 208 of the scheduling server 101.

FIG. 5 is a diagram exemplarily illustrating the configuration of an analysis processing server 102 according to the present embodiment.

FIG. 6 is a diagram exemplarily illustrating the configuration of an analysis program 306 in the analysis processing server 102.

FIG. 7 is a diagram exemplarily illustrating the configuration of a scheduling program 307 in the analysis processing server 102.

FIG. 8 is a diagram exemplarily illustrating the configuration of data stored in a non-volatile storage 309 of the analysis processing server 102.

FIG. 9 is a diagram exemplarily illustrating the configuration of an in-memory data storage server 103 according to the present embodiment.

FIG. 10 is a diagram exemplarily illustrating the configuration of data stored in a volatile storage 406 of the in-memory data storage server 103.

FIG. 11 is a diagram exemplarily illustrating the configuration of a database server 104 according to the present embodiment.

FIG. 12 is a diagram exemplarily illustrating the configuration of data stored in a non-volatile storage 507 of the database server 104.

FIG. 13 is a diagram exemplarily illustrating the content of a processing model 221 stored in the non-volatile storage 208 of the scheduling server 101.

FIG. 14 is a diagram exemplarily illustrating the content of an arithmetic performance definition 222 stored in the non-volatile storage 208 of the scheduling server 101.

FIG. 15 is a diagram exemplarily illustrating the content of a deletion definition table 223 stored in the non-volatile storage 208 of the scheduling server 101.

FIG. 16 is a diagram exemplarily illustrating the content of processing target data 511 as an analysis processing target.

FIG. 17 is a diagram exemplarily illustrating a GUI screen at execution of the schedule calculation program 206 by the scheduling server 101.

FIG. 18 is a diagram exemplarily illustrating the process of scheduling execution processing by the schedule calculation program 206.

FIG. 19 is a diagram exemplarily illustrating the process of data processing by a schedule calculator 211.

FIG. 20 is a diagram schematically and exemplarily illustrating the process of data processing by the schedule calculator 211.

FIG. 21 is a diagram exemplarily illustrating the process of schedule definition calculation processing.

FIG. 22 is a diagram exemplarily illustrating an evaluation function used at schedule calculation.

FIG. 23 is a diagram exemplarily illustrating the content of a schedule definition 331.

FIG. 24 is a diagram schematically illustrating the process of data processing based on the schedule definition 331.

FIG. 25 is a diagram illustrating an exemplary configuration of a shared data information table 332 in the analysis processing server 102.

FIG. 26 is a diagram exemplarily illustrating the process of data processing by the scheduling program 307 in the analysis processing server 102.

FIG. 27 is a diagram exemplarily illustrating a GUI screen at execution of the scheduling program 307 of the analysis processing server 102.

### DETAILED DESCRIPTION OF THE EMBODIMENTS

The following describes an embodiment of the present invention with reference to the accompanying drawings. In the embodiment described below, a distributed analysis system is assumed as an exemplary distributed system configured to perform data processing.

Configuration of Distributed Data Processing System

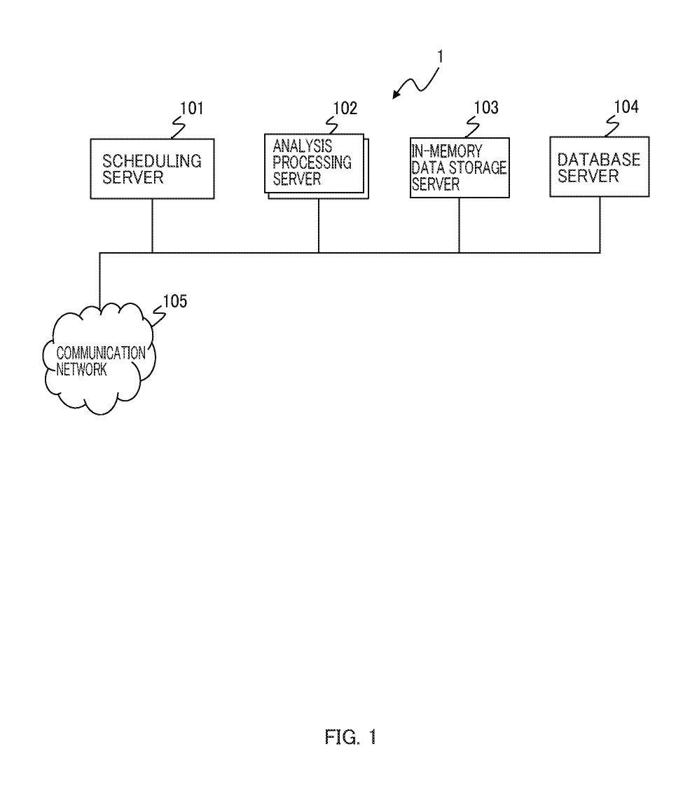

FIG. 1 is a diagram illustrating an exemplary system configuration of a distributed data processing system 1 according to the present embodiment. The distributed data processing system 1 includes a scheduling server 101, an analysis processing server 102 (data processing section), an in-memory data storage server 103, and a database server 104 (data storage) that are coupled with each other through a communication network 105 to perform communication therebetween. The communication network 105 is, for example, an intranet but may be a local area network (LAN), the Internet, a mobile communication network, a leased line, or the like.

The distributed data processing system 1 has a function to process analysis target large-volume data in a distributed manner at a plurality of the analysis processing servers 102. The scheduling server 101 is a server computer configured to calculate a schedule of distributed execution of analysis processing at the analysis processing servers 102 to be described later. Each analysis processing server 102 is a server computer configured to execute the data analysis processing in a distributed manner based on the schedule calculated by the scheduling server 101. As described above, in the present embodiment, a plurality of the analysis processing servers 102 are provided since analysis processing is assumed to be performed in a distributed manner, but distributed processing may be executed by, for example, a plurality of processors at one analysis processing server 102. The in-memory data storage server 103 is used as a storage place on a volatile memory for reference data or output data when analysis processing performed at each analysis processing server 102 is performed in accordance with the schedule calculated by the scheduling server 101. The database server 104 is used as a storage place on a non-volatile memory for reference data or output data when analysis processing performed at each analysis processing server 102 is performed in accordance with the schedule calculated by the scheduling server 101.

Exemplary Configuration of Scheduling Server 101

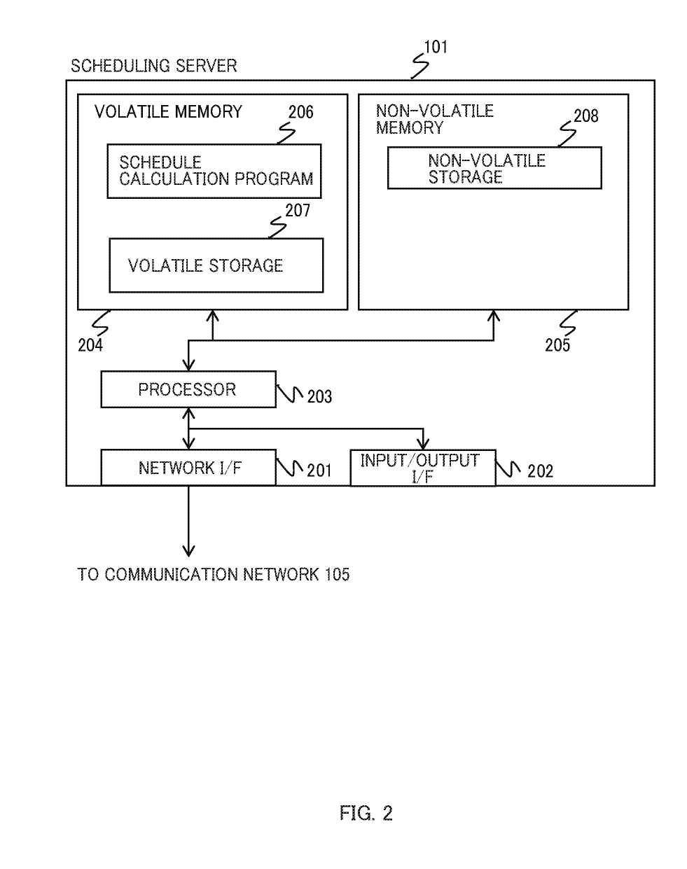

FIG. 2 is a diagram illustrating an exemplary hardware configuration of the scheduling server 101. The scheduling server 101 (scheduler) includes a network interface (network I/F) 201, an input and output interface (input/output I/F) 202, a processor 203 such as a CPU or an MPU, a volatile memory 204 such as a RAM, a non-volatile memory 205 such as an NVRAM or a ROM, and an internal communication line such as a bus coupling these components. The network I/F 201 includes, for example, a network interface card (NIC). The input/output I/F 202 includes an input/output device such as a keyboard or a monitor display. The volatile memory 204 provides a temporary data storage region. The scheduling server 101 is coupled with the communication network 105 through the network I/F 201.

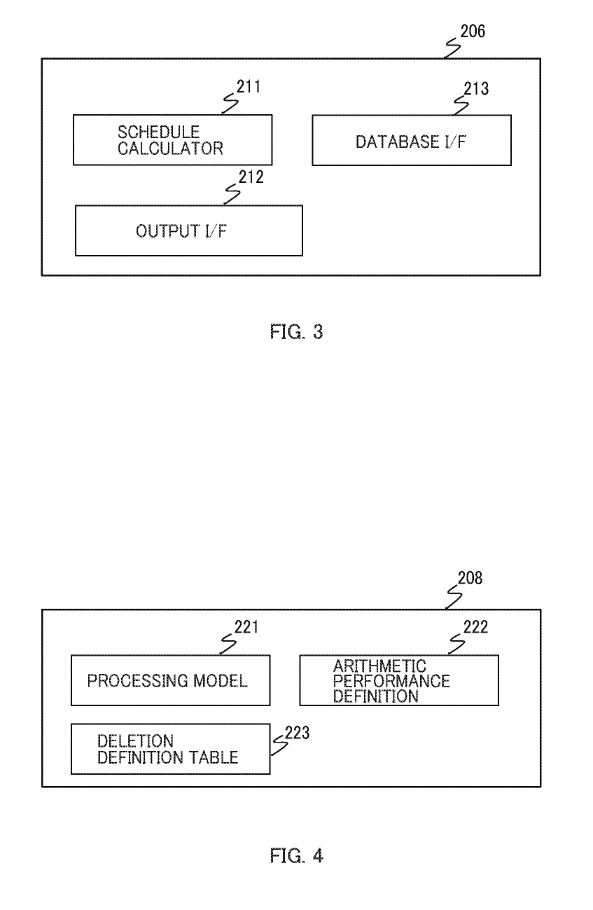

The volatile memory 204 stores a schedule calculation program 206 and includes a volatile storage 207 configured to store data. FIG. 3 illustrates an exemplary configuration of the schedule calculation program 206. The schedule calculation program 206 includes a schedule calculator 211, an output interface (output I/F) 212, and a database interface (database I/F) 213.

The schedule calculator 211 records various kinds of control programs that achieve processing of calculating, by the schedule calculation program 206, a schedule of analysis processing in a distributed manner at the analysis processing servers 102. These control programs are executed by the processor 203. The output I/F 212 records various kinds of control programs that achieve processing of reading an input file needed to perform the schedule calculator 211 and outputting calculated schedule data. These control programs are executed by the processor 203. The database I/F 213 records various kinds of control programs that achieve processing of reading input data needed to execute the schedule calculator 211. These control programs are executed by the processor 203.

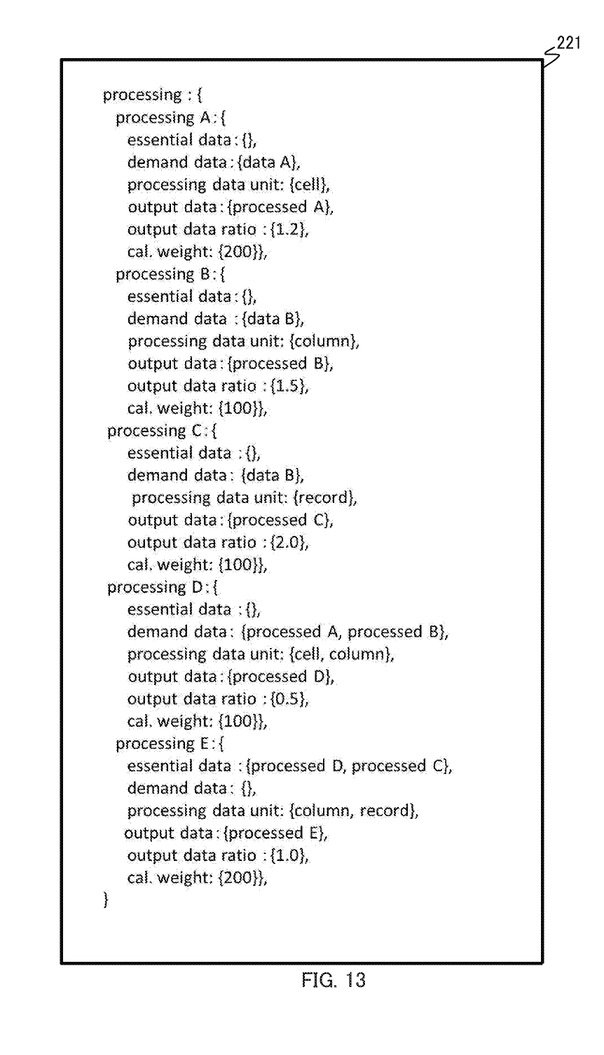

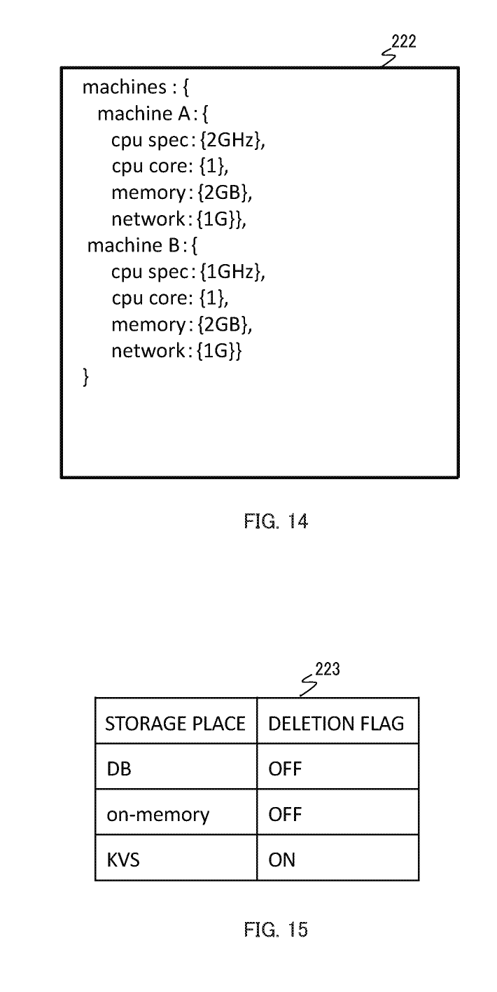

The non-volatile memory 205 includes a non-volatile storage 208. FIG. 4 illustrates an exemplary configuration of the non-volatile storage 208. The non-volatile storage 208 stores data managed by the schedule calculation program 206 and includes a processing model 221, an arithmetic performance definition 222, and a deletion definition table 223. The processing model 221 is a file that defines the content of processing executed by an analysis program 306 in each analysis processing server 102. The arithmetic performance definition 222 is a file that defines arithmetic performance of each analysis processing server 102 executing the analysis program 306. The deletion definition table 223 is a file that defines, in advance before analysis processing starts at each analysis processing server 102, whether to save a used data capacity by deleting, as appropriate, data held in an on memory used as a data temporary storage region by the in-memory data storage server 103, the database server 104, and a processor 303. In the following, FIG. 13 illustrates an exemplary configuration of the processing model 221, FIG. 14 illustrates an exemplary configuration of the arithmetic performance definition 222, and FIG. 15 illustrates an exemplary configuration of the deletion definition table 223. These three files will be separately described with reference to FIGS. 13 to 15.

Exemplary Configuration of Analysis Processing Servers 102

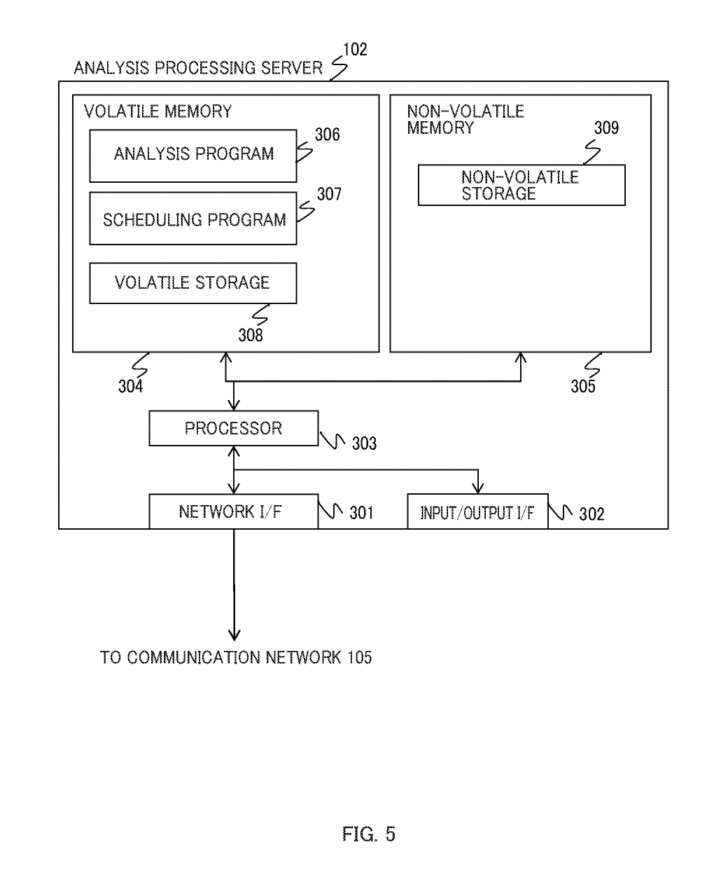

FIG. 5 is a diagram illustrating an exemplary hardware configuration of each analysis processing server 102. The analysis processing server 102 includes a network I/F 301, an input/output I/F 302, the processor 303, a volatile memory 304, a non-volatile memory 305, and an internal communication line such as a bus coupling these components. The analysis processing server 102 is coupled with the communication network 105 through the network I/F 301. Description of any component similarly to that of the scheduling server 101 is omitted.

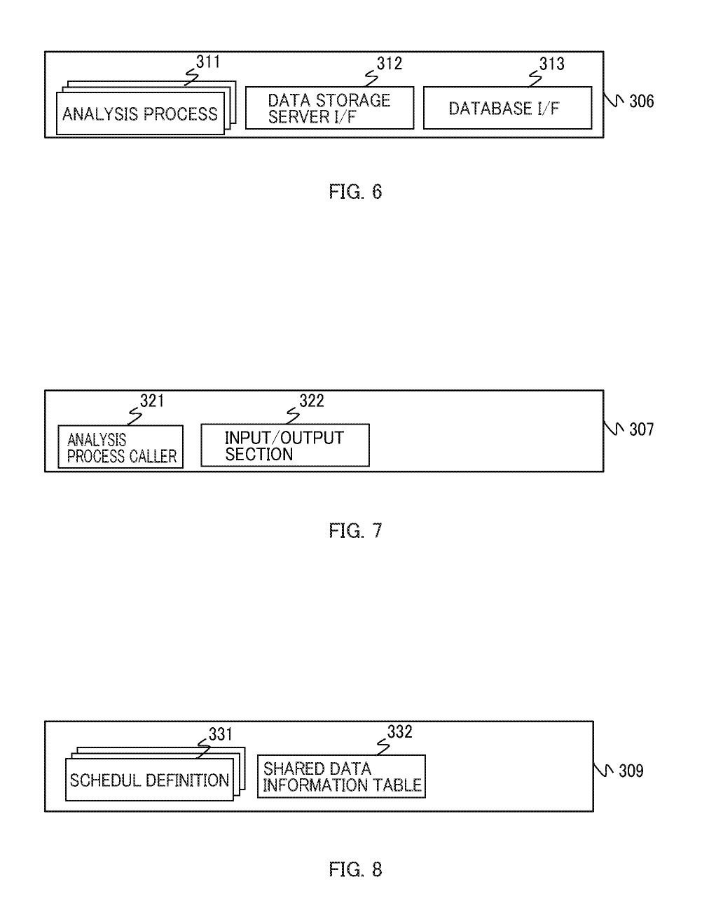

The volatile memory 304 includes the analysis program 306, a scheduling program 307, and a volatile storage 308 configured to store data. FIG. 6 illustrates an exemplary configuration of the analysis program 306. The analysis program 306 includes a plurality of analysis processes 311 of the analysis program 306, a data storage server interface (data storage server I/F) 312 configured to communicate data with the in-memory data storage server 103, and a database I/F 313 configured to communicate data with the database server 104. The analysis program 306 is executed by the processor 303.

FIG. 7 illustrates an exemplary configuration of the scheduling program 307. The scheduling program 307 is an auxiliary program configured to operate the analysis program 306 according to the schedule calculated by the scheduling server 101. The scheduling program 307 includes an analysis process caller 321 configured to call the analysis processes 311 of the analysis program 306, and an input/output section 322 configured to read a schedule. The scheduling program 307 is executed by the processor 303. The volatile storage 308 stores data managed by the analysis program 306, and data managed by the scheduling program 307.

The non-volatile memory 305 includes a non-volatile storage 309. FIG. 8 illustrates an exemplary configuration of the non-volatile storage 309. The non-volatile storage 309 stores data managed by the analysis program 306, and data managed by the scheduling program 307. The non-volatile storage 309 also stores a schedule definition 331 and a shared data information table 332.

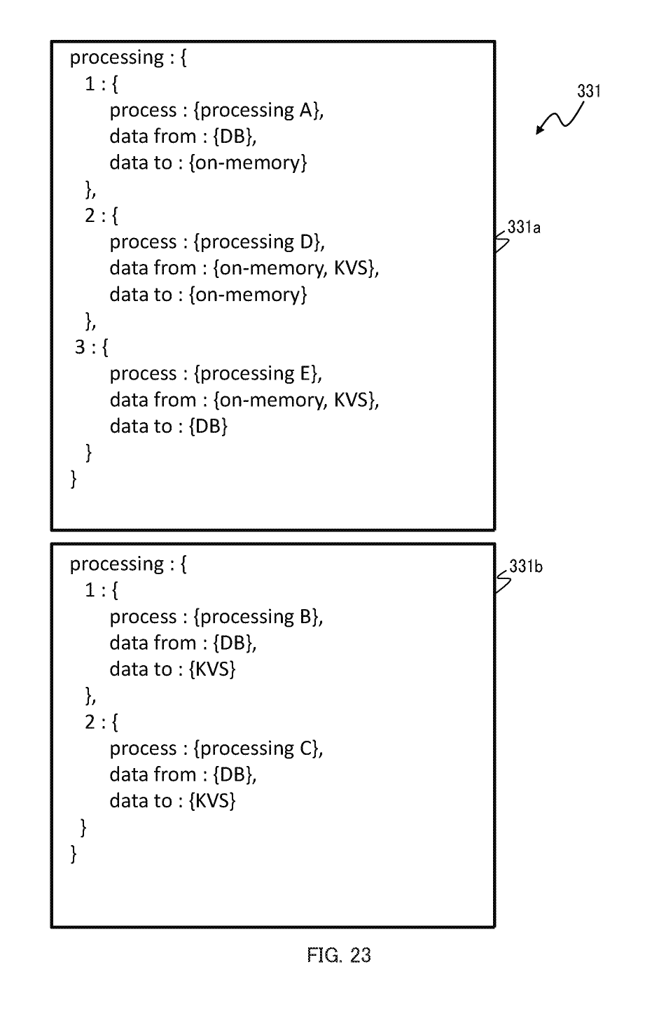

The schedule definition 331 (data processing schedule) describes an execution procedure of the analysis program 306, which is referred to when the analysis program 306 is executed in a distributed manner. The schedule definition 331 is generated by the schedule calculation program 206 of the scheduling server 101. FIG. 23 to be described later illustrates an exemplary configuration of the schedule definition 331.

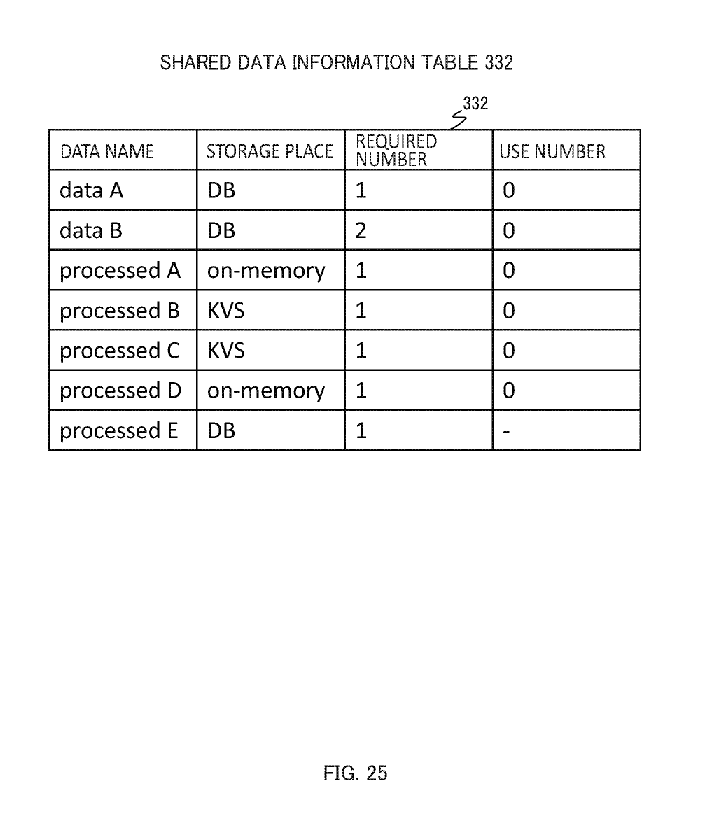

The shared data information table 332 is referred to and updated when the analysis program 306 is executed in a distributed manner. The shared data information table 332 is collectively lists storage places of reference data and output data of the analysis program 306. The shared data information table 332 is generated by the schedule calculation program 206 of the scheduling server 101. FIG. 25 to be described later illustrates an exemplary configuration of the shared data information table 332. The schedule definition 331 and the shared data information table 332 will be described later with reference to FIGS. 23 and 25.

### Exemplary Configuration of In-Memory Data Storage Server 103

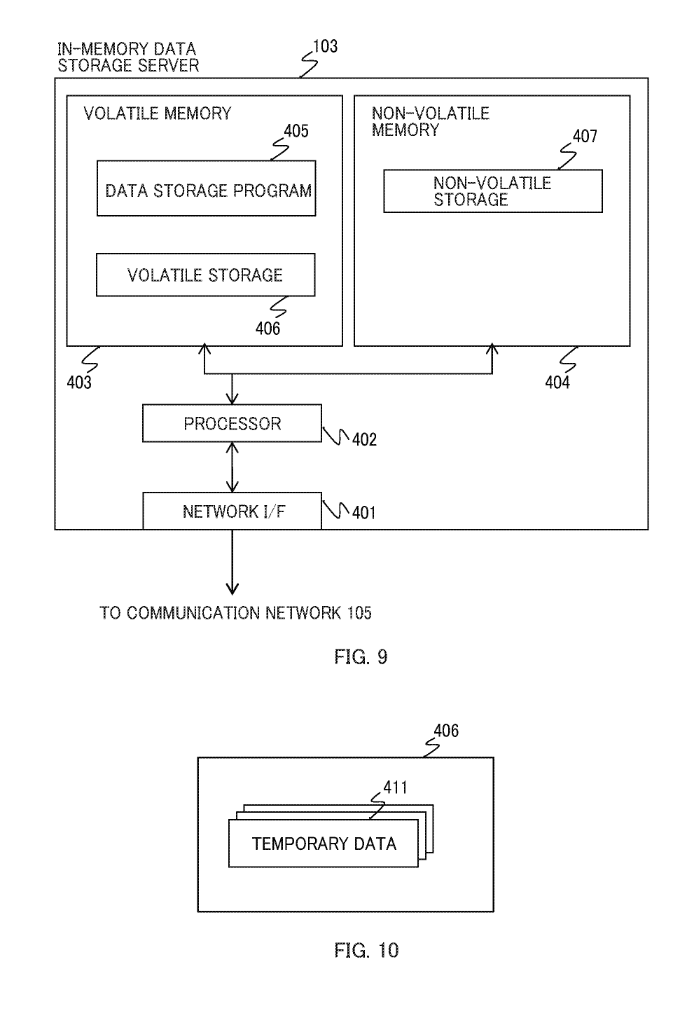

FIG. 9 illustrates an exemplary hardware configuration of the in-memory data storage server 103. The in-memory data storage server 103 includes a network I/F 401, a processor 402, a volatile memory 403, a non-volatile memory 404, and an internal communication line such as a bus coupling these components. The in-memory data storage server 103 is coupled with the communication network 105 through the network I/F 401. Description of any component similarly to that described above is omitted.

The volatile memory 403 includes a data storage program 405 and a volatile storage 406 configured to store data. The data storage program 405 records a computer program for storing and reading data in the volatile storage 406 on the volatile memory 403. The data storage program 405 is executed by the processor 402. FIG. 10 illustrates an exemplary configuration of the volatile storage 406. The volatile storage 406 stores a plurality of pieces of temporary data 411, and data managed by the data storage program 405. The temporary data 411 is reference data written or read by the data storage program 405 in execution. The temporary data 411 is stored in a volatile storage region and thus is not persistent data.

The non-volatile memory 404 includes a non-volatile storage 407. The non-volatile storage 407 stores data managed by the data storage program 405.

### Exemplary Configuration of Database Server 104

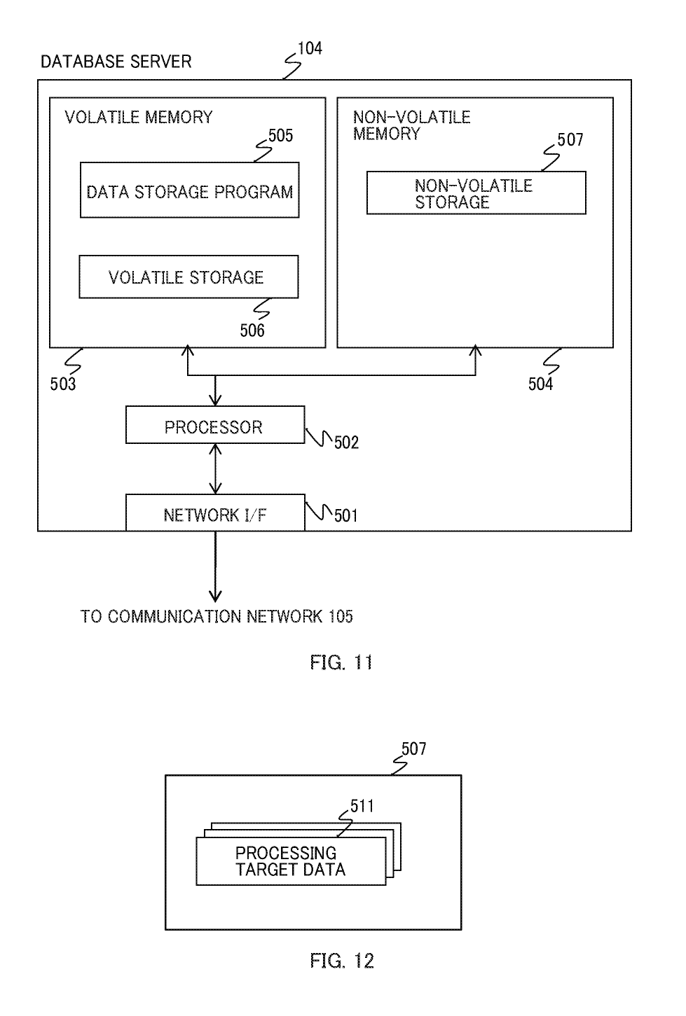

FIG. 11 illustrates an exemplary hardware configuration of the database server 104. The database server 104 includes a network I/F 501, a processor 502, a volatile memory 503, a non-volatile memory 504, and an internal communication line such as a bus coupling these components. The database server 104 is coupled with the communication network 105 through the network I/F 501. Description of any component similarly to that described above is omitted.

The volatile memory 503 includes a database program 505 and a volatile storage 506 configured to store data. The database program 505 is a computer program for storing and reading data in a non-volatile storage 507 on the non-volatile memory 504. The database program 505 is executed by the processor 502. The volatile storage 506 stores data managed by the database program 505.

The non-volatile memory 504 includes a non-volatile storage 507. FIG. 12 illustrates an exemplary configuration of the non-volatile storage 507. The non-volatile storage 507 stores a plurality of pieces of processing target data 511, and data managed by the database program 505. The processing target data 511 is reference data written or read by the database program. 505 in execution.

### Exemplary Configuration of Processing Model 221

FIG. 13 illustrates an exemplary configuration of the processing model 221 (data processing model) stored in the non-volatile storage 208 of the scheduling server 101. The processing model 221 is a file that defines specification of data to be actually processed by the analysis program 306 of the analysis processing server 102. In the example illustrated in FIG. 13, the processing model 221 is described in JavaScript Object Notation (JSON) format (JavaScript is a registered trademark) as one of data description languages, but the data description format is not limited thereto.

The processing model 221 in the present embodiment includes the items of essential input data (“essential data”) that is input data essential for execution of the analysis processes 311 of the analysis program 306, demand input data (“demand data”) that is input data needed to execute the analysis processes 311, processing unit of input data (“processing data unit”), output data from an executed analysis process (“output data”), an output data ratio (“output data ratio”), and a process processing weight (process processing load) (“cal.weight”). The essential input data indicates data required to be written to execute a target process and allows specification of a plurality of pieces of data separated by comma (,) in the example illustrated in FIG. 13. The demand input data indicates data that is required to be written to execute a target process but can be, for example, calculated again when not provided. Similarly to the essential input data, the demand input data allows specification of a plurality of pieces of data separated by comma (,). The processing unit of input data indicates a unit in which the input data is processed by a target process. For example, the process processes the input data cell by cell when the processing input data unit is “cell”, column by column when the processing input data unit is “column”, or record by record when the processing input data unit is “record”. The processing input data unit corresponds to each of the essential input data and the demand input data. For example, when one pieces of data is written in the essential input data and two pieces of data are written in the demand input data, three units are written in the processing input data unit, the first unit corresponding to the essential input data and the other two units corresponding to the demand input data. The output data is an identifier for identifying data output after completed execution of a target process, and allows specification of a plurality of identifiers separated by comma (,). The output data ratio is the ratio of output data of a target process relative to input data and indicates the degree of increase or decrease of the output data relative to the input data in data size. For example, when a target process is processing of converting upper case data into lower case data, input data and output data have the same size, and thus the output data ratio is 1.0. When the number of characters in the output data is increased by 50% as compared to the input data, the output data ratio is 1.5. The process processing weight is the weight of processing needed to execute a target process. For example, a weighting value with respect to an execution time of a CPU is written in the process processing weight.

In this manner, distributed processing is planned based on a model in accordance with the content of processing to be actually executed by the analysis processes 311, which achieves a distributed processing plan appropriate for the individual analysis program 306.

### Exemplary Configuration of Arithmetic Performance Definition 222

FIG. 14 illustrates an exemplary configuration of the arithmetic performance definition 222 stored in the non-volatile storage 208 of the scheduling server 101. The arithmetic performance definition 222 is a file that defines the performance of a computer included in the analysis processing server 102 on which the analysis program 306 operates. Similarly to the processing model 221, the arithmetic performance definition 222 exemplarily illustrated in FIG. 14 is described in the JSON format, but the data description format is not limited thereto. The arithmetic performance definition 222 in the present embodiment includes the items of CPU performance (“cpu spec”) of each analysis processing server 102, the number of CPU cores (“cpu core”), a memory capacity (“memory”), and a network band (“network”). The CPU performance indicates the clock rate of a CPU included in each analysis processing server 102. The number of CPU cores indicates the number of cores included in the CPU of the analysis processing server 102. The CPU means the processor 303 in FIG. 5. A core included in each processor 303 is also referred to as a “calculation execution unit”. The memory capacity indicates the storage capacity of a memory mounted on the analysis processing server 102. The network band indicates the upper limit of a network band supported by the network I/F 301 included in the analysis processing server 102. The arithmetic performance definition 222 allows the scheduling server 101 to perform a schedule production with taken into account the performance of the analysis processing server 102 as a computer.

### Exemplary Configuration of Deletion Definition Table 223

FIG. 15 illustrates an exemplary configuration of the deletion definition table 223 stored in the non-volatile storage 208 of the scheduling server 101. The deletion definition table 223 defines whether reference data used by the analysis program 306 of the analysis processing server 102 when performing analysis processing is to be deleted at a timing when the data becomes unnecessary. The deletion definition table 223 exemplarily illustrated in FIG. 15 lists three deletion definitions for a case in which the reference data is located on the database server 104 (“DB”), a case in which the reference data is located a memory of the analysis processing server 102 (“on-memory”), and a case in which the reference data is located the in-memory data storage server 103 (“KVS”). In the example illustrated in FIG. 15, the sign “KVS” is listed in the deletion definition table 223 because data is stored in the Key Value Store (KVS) format in the volatile storage 406 of the in-memory data storage server 103. In the example illustrated in FIG. 15, a deletion flag is set to be “OFF” when the storage place of data is “DB” or “on-memory”, or “ON” when the storage place is “KVS”. Thus, at execution of the analysis program 306, the reference data is not deleted after execution of an analysis process referring to the data when the data is located on the DB or the memory of the analysis processing server 102, but the data is deleted after execution of an analysis process referring to the data when the storage place is the KVS. The deletion definition table 223 allows efficient use of the data storage capacity of the entire system.

### Processing Target Data 511 of Database Server 104

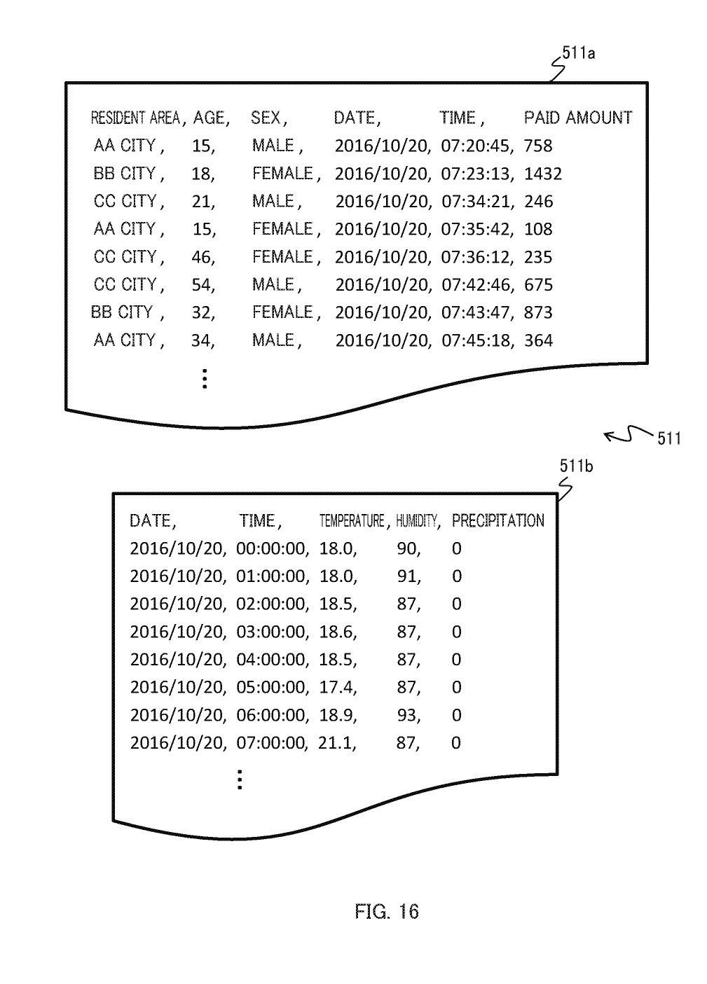

FIG. 16 is a diagram illustrating an exemplary configuration of the processing target data 511 stored in the non-volatile storage 507 of the database server 104. The processing target data 511 is used as reference data by the analysis program 306 of the analysis processing server 102 when performing analysis processing. In the present embodiment, it is assumed that two pieces of processing target data 511a and 511b as reference sources are processed. The processing target data 511a and 511b each include a column (longitudinal direction) and a record (lateral direction). Data is stored in each column of each record. In each record, pieces of data are separated by comma (,). This format is typically called a csv file format. Any format that allows data to be referred to by the analysis program 306 when performing analysis processing is applicable. The processing target data 511 may be managed on the database program 505 without being stored in the non-volatile storage 507 in the database server 104.

Exemplary Configuration of GUI Screen of Schedule Calculation Program 206

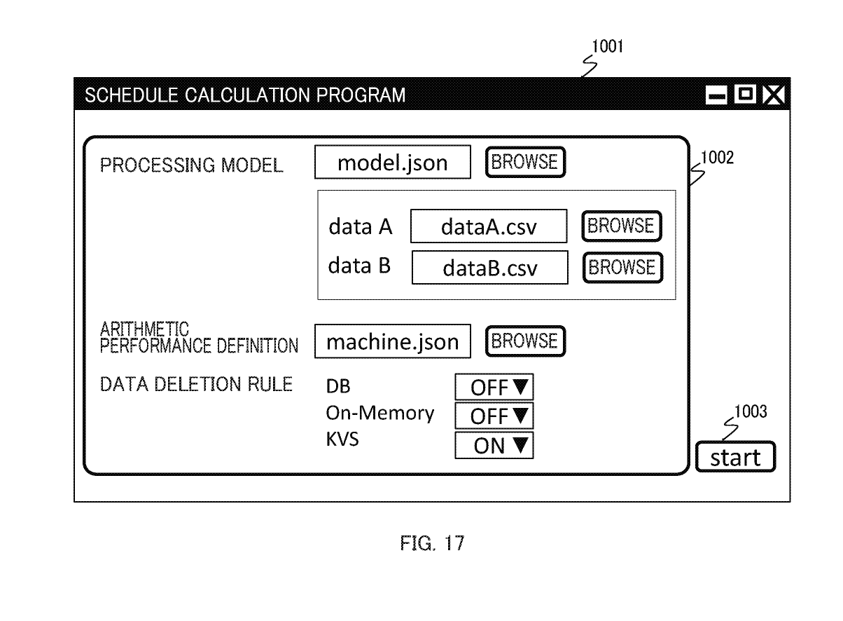

FIG. 17 is a diagram exemplarily illustrating a GUI screen when the schedule calculation program 206 is operational. This GUI screen 1001 includes an input interface 1002 through which information needed to execute the schedule calculation program 206 is input, and an execution button 1003 for instructing execution of the schedule calculation program 206.

The input interface 1002 receives inputting of a processing model, data referred to by the analysis program 306 when performing analysis processing, an arithmetic performance definition, and a data deletion rule. In the section of the processing model, the processing model 221 described with reference to FIG. 13 can be input through selection of a file thereof by pressing a browse button. The processing target data 511 described with reference to FIG. 16 as the data referred to by the analysis program 306 when performing analysis processing can be input through selection of a file thereof by pressing a browse button. For the data referred to by the analysis program 306 when performing analysis processing, the number of pieces of data necessary for inputting can be analyzed from the processing model input through the above-described procedure. For example, in the processing model 221 described with reference to FIG. 13, since only data A and data B are written as reference data in the essential input data and the demand input data, data A and data B are needed to be input in the section of the data referred to by the analysis program 306 when performing analysis processing, in the input interface 1002. Data denoted by “processed” in the processing model 221 is data output halfway through by the corresponding process, and thus can be excluded from data specified in the section of the processing model. Inputting of data to be actually processed by the analysis program 306 allows production of a schedule suitable for the characteristics (for example, an extremely large of columns, and a large number of bytes in one cell) of the input data. In the section of the arithmetic performance definition, the arithmetic performance definition 222 described with reference to FIG. 14 can be input through selection of a file thereof by pressing a browse button. The section of the data deletion rule receives inputting by selecting, in the deletion definition table 223 described with reference to FIG. 15, “ON” or “OFF” for each of deletion definitions related to three patterns of a case in which reference data is located on the DB, a case in which reference data is located on the memory of the analysis processing server 102 (on-memory), and a case in which reference data is located on the KVS.

The schedule calculation program 206 can be operated by inputting all of the processing model, the data referred to by the analysis program 306 when performing analysis processing, the arithmetic performance definition, and the data deletion rule on the input interface 1002 and operating the execution button 1003.

### Exemplary Data Processing Process

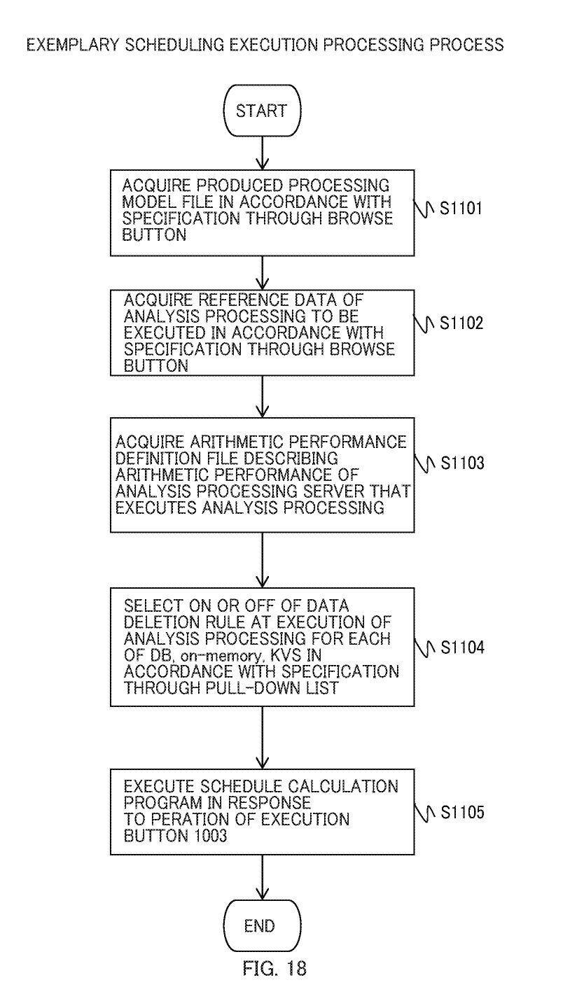

The following describes data processing executed by the distributed data processing system 1 thus configured. FIG. 18 is a flowchart illustrating exemplary data processing by the schedule calculation program 206 of the scheduling server 101.

The schedule calculation program 206 first acquires the file of the produced processing model 221 from the input interface 1002 on the GUI screen 1001 in accordance with inputting through the browse button (S1101). When the processing model 221 input by a user is properly read, the schedule calculation program 206 calculates the name of needed reference data and the number thereof, and then displays again the data as an input item on the input interface 1002 on the GUI screen 1001.

Subsequently, the schedule calculation program 206 acquires reference data of analysis processing to be executed, which is input through the browse button on the input interface 1002 on the GUI screen 1001 (S1102).

Subsequently, the schedule calculation program 206 acquires the file of the arithmetic performance definition 222 describing the performance of the analysis processing server 102 executing the analysis processing, as a computer, the file being input through the browse button on the input interface 1002 on the GUI screen 1001 (S1103).

Subsequently, the schedule calculation program 206 acquires, from the deletion definition table 223, the data deletion rule of “ON” or “OFF”, which is selected from a pull-down list for each of “DB”, “on-memory”, and “KVS” on the input interface 1002 on the GUI screen 1001 (S1104).

Lastly, the schedule calculation program 206 executes data processing for scheduling in response to operation of the execution button 1003 on the GUI screen 1001 (S1105).

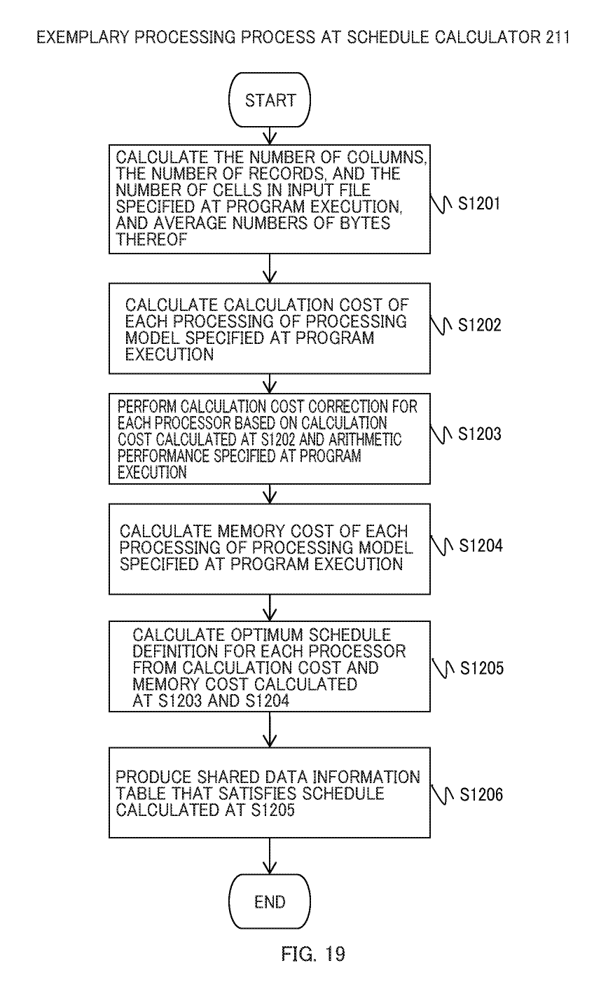

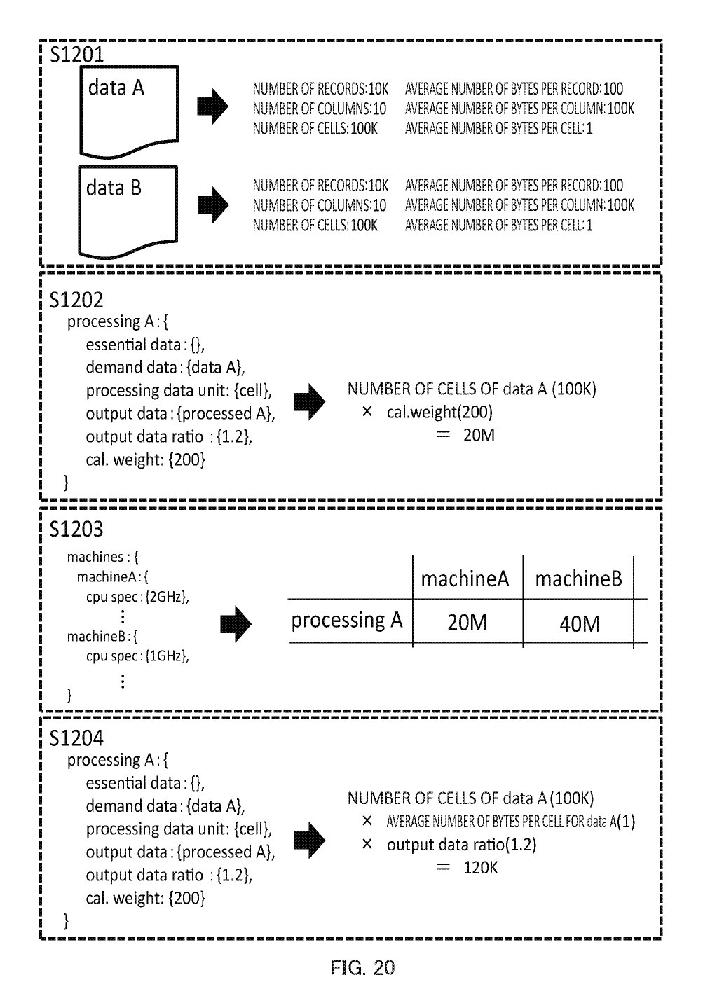

The following describes schedule calculation processing by the schedule calculator 211 of the scheduling server 101. FIG. 19 illustrates a flowchart of schedule calculation by the schedule calculator 211 of the scheduling server 101. FIG. 20 illustrates diagrams for supplement description of processing steps S1201 to S1204 in the flowchart illustrated in FIG. 19. The schedule calculation processing will be described below with reference to FIGS. 19 and 20.

First, having started the processing illustrated in FIG. 19, the schedule calculator 211 calculates the number of columns, the number of records, and the number of cells in an input file specified at execution of the program, and average numbers of bytes thereof (S1201). The input file means data referred to by the analysis program 306 when performing analysis processing which is input through the input interface 1002 illustrated in FIG. 17, and thus corresponds to the processing target data 511 exemplarily illustrated in FIG. 16. For example, when data A and data B are provided as input files, the numbers of pieces of data in the row direction (record) and the column direction (column) in each of the files of data A and data B are calculated and set as the number of records and the number of columns, respectively. The number of cells is calculated as the product of the number of records and the number of columns. In addition, the number of bytes of each file is divided by each of the number of records, the number of columns, and the number of cells to calculate the average number of bytes thereof.

Subsequently, the schedule calculator 211 calculates a calculation cost of each processing of the processing model specified at execution of the program (S1202). Specifically, the processing model input through the input interface 1002 illustrated in FIG. 17 is referred to, and the calculation cost is calculated as the product of the number of references of reference data and the process processing weight of the processing model. For example, in the processing model 221 illustrated in FIG. 13, when data A is input in cell unit (“processing data unit”=“cell”) in processing A of the processing model 221, the process processing weight (“cal.weight”) is 200, and the number of cells in data A is 100 K, the calculation cost is calculated to be 100 K×200=20 M. K represents the unit of 1,000, and M represents the unit of 1,000,000.

Subsequently, the schedule calculator 211 performs calculation cost correction for each processor based on the calculation cost calculated at S1202 and the arithmetic performance specified at execution of the program (S1203). Specifically, the arithmetic performance definition input through the input interface 1002 illustrated in FIG. 17 is referred to, and the calculation cost calculated at S1202 is normalized with the value of the CPU performance in the arithmetic performance definition. For example, at S1202, the calculation cost is calculated to be 20 M for processing A in the processing model 221. When the CPU performance of the arithmetic performance definition 222 is 2 GHz for machine A and 1 GHz for machine B, the performance of machine A is twice as high as that of machine B. Thus, to execute the calculation cost of 20 M calculated at S1202, machine B takes a cost twice as high as that taken by machine A, in other words, needs a calculation time twice as long as that taken by machine A. Thus, the calculation cost is calculated to be 20 M when processing A is executed by machine A, the calculation cost is calculated to be 40 M when processing A is executed by machine B.

Subsequently, the schedule calculator 211 calculates a memory cost for each output data of the processing model specified at execution of the program (S1204). Specifically, the processing model 221 input through the input interface 1002 illustrated in FIG. 17 is referred to, and the memory cost is calculated by multiplying the number of references of reference data, a reference data byte number of reference data, and the output data ratio. For example, when data A is input in cell unit in processing A of the processing model 221, the output data ratio of data A is 1.2, the number of cells of data A is 100 K, the average number of bytes per cell for data A is 1, the memory cost of processed A is calculated to be 100 K×1×1.2=120 K. The memory cost can be understood as the size of a storage region occupied by output data of each analysis process 311. The calculation cost and the memory cost are each referred to as a “system requirement index”. The system requirement index is not limited to a calculation cost related to the processor arithmetic performance and the memory cost related to a memory use amount described above, but may be another index such as a network load on the communication network 105.

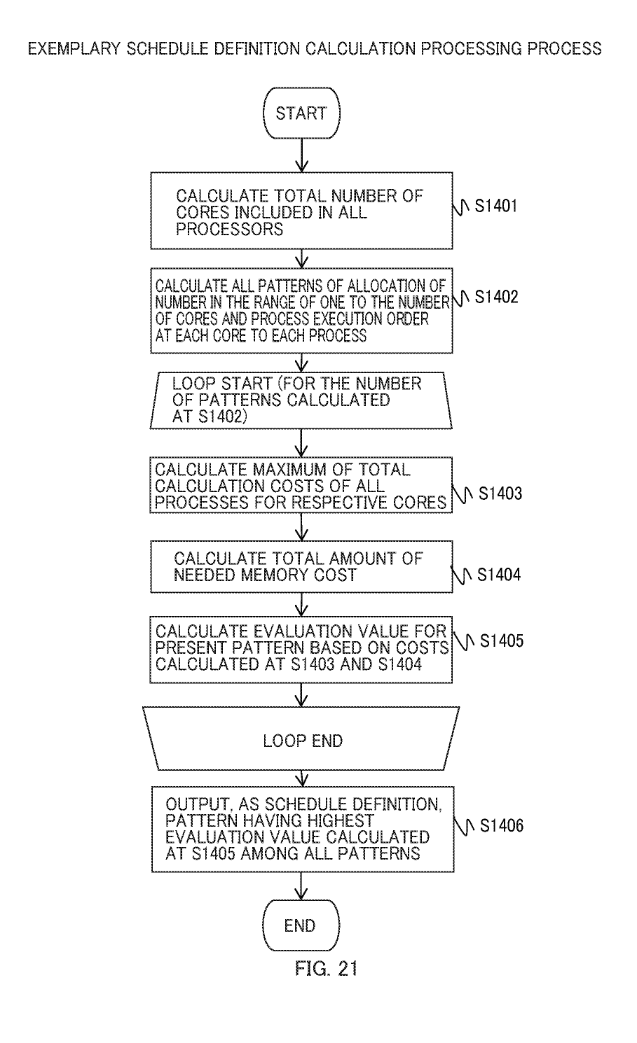

Subsequently, the schedule calculator 211 calculates an optimum schedule definition for each processor from the calculation cost and memory cost calculated at S1203 and S1204 (S1205). The data processing at S1205 will be described in detail with reference to a flowchart illustrated in FIG. 21.

Lastly, the schedule calculator 211 produces the shared data information table 332 that satisfies the schedule calculated at S1205 (S1206). Specifically, the schedule calculator 211 produces the shared data information table 332 by comparing the processing model 221 and the schedule definition 331 with each other. For example, it is understood from the processing model 221 illustrated in FIG. 13 that processing A executes data processing with data A as an input and outputs processed A. It is understood from the schedule definition 331 exemplarily illustrated in FIG. 23 to be described later that processing A acquires an input from the DB, and an output thereof is stored in the on memory. Thus, the schedule calculator 211 can calculate the shared data information table 332 in which the storage place of data A is the DB and the required number thereof is one. The shared data information table 332 will be described in detail below with reference to FIG. 25.

The following describes the data processing by the schedule calculator 211 at S1205 illustrated in FIG. 19. FIG. 21 illustrates a flowchart that achieves the data processing at S1205 illustrated in FIG. 19.

First, the schedule calculator 211 calculates the total number of cores included in the processors 303 of the analysis processing servers 102 (S1401). Specifically, the schedule calculator 211 sums all of the numbers of CPU cores in the arithmetic performance definition by referring to the arithmetic performance definition 222 input through the input interface 1002 illustrated in FIG. 17.

Subsequently, the schedule calculation program 206 calculates all patterns of allocation of a number in the range of one to the number of cores and a process execution order at each core to each process of the analysis program 306 (S1402). Specifically, the schedule calculator 211 allocates, to each process described in the processing model 221, a number in a range having an upper limit at the number of cores calculated at S1401. For example, in the present embodiment, five processes of processing A, processing B, processing C, processing D, and processing E are described in the processing model 221, the sum of the numbers of CPU cores in the arithmetic performance definition 222 is two, and processing target data is the processing target data 511. Accordingly, a pattern in which the number of one or two is allocated to each of the above-described processes is produced. As a result, for example, when core 1 is allocated to processing A, core 2 is allocated to processing B, core 2 is allocated to processing C, core 1 is allocated to processing D, and core 1 is allocated to processing E, such a schedule is produced that processing A, processing D, and processing E are executed by the first core (in the example of the arithmetic performance definition 222 illustrated in FIG. 14, machine A) and processing B and processing C are executed by the second core (in the example of the arithmetic performance definition 222 illustrated in FIG. 14, machine B). As described above, such a schedule is produced for each of all combinations of the processes and the CPU cores at S1402. The combinations may be produced by any method such as width-first search or depth-first search.

The following processing steps S1403 to S1405 is repeatedly executed a number of times equal to the number of schedule patterns calculated by the schedule calculator 211 at S1402.

Subsequently, the schedule calculator 211 calculates the maximum one of the total calculation costs of all processes calculated for the respective CPU cores (S1403). For example, when core 1 is allocated to processing A, core 2 is allocated to processing B, core 2 is allocated to processing C, core 1 is allocated to processing D, and core 1 is allocated to processing E, the schedule calculator 211 calculates the sum (referred to as a machine A calculation cost) of calculation costs when processing A, processing D, and processing E are executed by machine A, and also calculates the sum (referred to as a machine B calculation cost) calculation costs when processing B and processing C are executed by machine B. Then, the larger one of the machine A calculation cost and the machine B calculation cost is obtained.

Subsequently, the schedule calculator 211 calculates the total amount of needed memory cost (S1404). The memory cost is a cost taken for data needed to be stored in the in-memory data storage server 103. However, cost taken for data stored in the on memory or cost taken for data stored in the DB may be employed as an index in accordance with specification required for the distributed data processing system 1, and the above-described memory cost may be used together. When core 1 is allocated to processing A, core 2 is allocated to processing B, core 2 is allocated to processing C, core 1 is allocated to processing D, and core 1 is allocated to processing E, two pieces of output data, processed B and processed C, are needed to be stored in the in-memory data storage server 103. Thus, the schedule calculator 211 acquires the memory cost (1.5 M) of processed B and the memory cost (2 M) of processed C by referring to the processing model 221 illustrated in FIG. 13, and calculates the sum thereof.

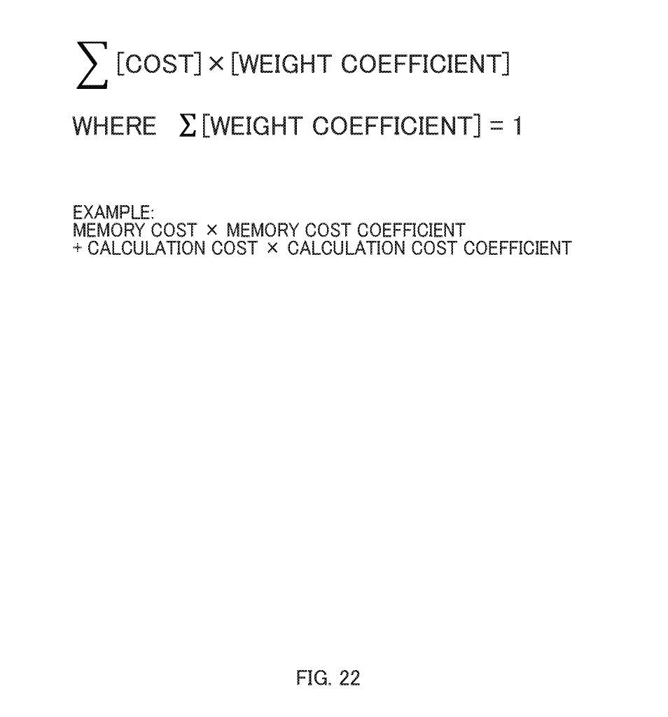

Subsequently, the schedule calculator 211 calculates an evaluation value for the present pattern by applying an evaluation function based on the costs calculated at S1403 and S1404 (S1405). The calculation procedure of this evaluation value will be described later with reference to FIG. 22.

Lastly, the schedule calculator 211 outputs, as a schedule definition, a pattern having the highest evaluation value calculated at S1405 among all patterns (S1406). The schedule definition is output in a number equal to the total number (in the present example, two) of cores in the processor 303 that executes an analysis process. The output schedule definitions are forwarded to the non-volatile storage 309 of the analysis processing servers 102 to be read as an input to the scheduling program 307 of the analysis processing servers 102.

FIG. 22 illustrates an exemplary evaluation function used when schedule evaluation is performed at S1406 in the exemplary process of schedule definition calculation processing illustrated in FIG. 21. The evaluation function calculates as the sum of each cost×a weight coefficient of the cost. The weight coefficient of each cost is set so that the sum thereof is equal to one. An evaluation index used for the evaluation function can be optionally determined. For example, a memory storage capacity and a calculation time are used as the evaluation indexes. In this case, for example, the memory cost is 120 K, the memory cost coefficient is 0.8, the calculation time is 20 M, and the calculation time cost coefficient is 0.2. When the memory cost is normalized with 10 K and the calculation cost is normalized with 10 M, the evaluation value is calculated to be (120 K/10 K)×0.8+(20 M/10 M)×0.2=10 in normalization processing. In this example, since the memory cost coefficient is 0.8 and the calculation time cost coefficient is 0.2, a calculated schedule is optimum from the viewpoint of the efficiency of memory use. Alternatively, for example, when the memory cost coefficient is 0.2 and the calculation time cost coefficient is 0.8, a calculated schedule is more preferable from the viewpoint of the efficiency of a calculation time. In this manner, a schedule suitable for the executed analysis program 306 and the analysis processing server 102 can be produced by changing the weight coefficients in accordance with a system requirement.

### Exemplary Configuration of Schedule Definition 331

FIG. 23 is a diagram illustrating an exemplary configuration of the schedule definition 331 stored in the non-volatile storage 309 of the analysis processing server 102. The schedule definition 331 is a file that defines a processing order when the analysis program 306 of the analysis processing server 102 is executed in a distributed manner. The schedule definition 331 is calculated by the schedule calculation program 206 of the scheduling server 101. When the analysis program 306 is executed, the schedule definition 331 is needed in a number equal to the number of the analysis processing servers 102 that execute the analysis program 306. In the present embodiment, it is assumed that the two analysis processing servers 102 operate in the distributed data processing system 1, and thus the two schedule definitions 331 are needed for the respective analysis processing servers 102.

The schedule definition 331 includes the three items of the name of an analysis process to be executed (“process”), a place (“data from”) where reference data needed to execute the analysis process is stored, a place (“data to”) where data output after the analysis process is executed is stored. These items are described in the order of execution by the corresponding analysis processing server 102. The analysis process name (“process”) indicates the name of the analysis process to be executed by the analysis processing server 102 in a name defined in the processing model 221. The storage place (“data from”) of the reference data and the storage place (“data to”) of the output data each indicate the corresponding one of the DB, the on memory, and the KVS.

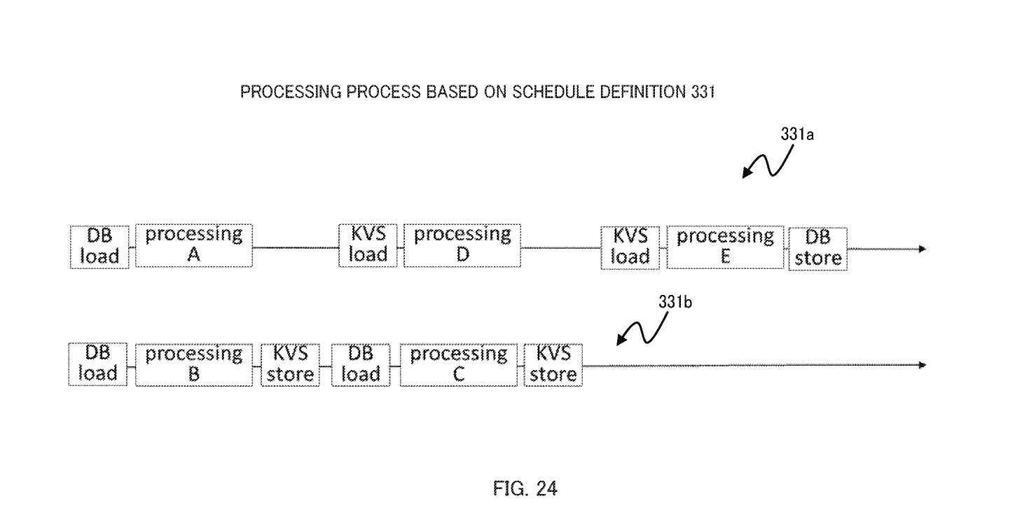

FIG. 24 is a diagram schematically illustrating the content of processing executed in accordance with the schedule definition 331 exemplarily illustrated in FIG. 23. Since the schedule definition 331 illustrated in FIG. 23 includes schedules for the two analysis processing servers 102, FIG. 24 illustrates the content for the two analysis processing servers 102.

The following describes one schedule definition 331a illustrated in FIG. 23. In the first procedure, data is acquired from the DB, processing A is executed, and output data is output onto the on memory. Thus, the data loading from the DB (“DB load”) and processing A are illustrated in the procedure. The outputting of the output data to the on memory is completed when normal processing (in this example, processing A) is performed, and thus not illustrated in the procedure. Subsequently, in the second procedure, data is acquired from the on memory and the KVS, processing D is executed, and output data is output onto the on memory. Thus, the data loading from the KVS (“KVS load”) and processing D are illustrated in the procedure. Similarly to the above-described data output onto the on memory, the loading of the input data from the on memory is not illustrated in the procedure. In the third procedure, data is acquired from the on memory and the KVS, processing E is executed, and output data is output onto the DB. Thus, the data loading from the KVS (“KVS load”), the execution of processing E, and data output to the DB (“DB store”) are illustrated in the procedure. A schedule definition 331b illustrated in FIG. 24 is illustrated in a manner similar to that of the schedule definition 331a. The illustration indicates that predetermined data is loaded and processing B and processing C are executed.

In the above-described schedule definition 331, data needed to execute processing D and processing E in the second and third procedures of the schedule definition 331a is not produced until processing B and processing C included in the procedure of the schedule definition 331b end. Thus, processing wait occurs in the schedule definition 331b until these pieces of processing end.

### Exemplary Configuration of Shared Data Information Table 332

FIG. 25 is a diagram illustrating an exemplary configuration of the shared data information table 332 stored in the non-volatile storage 309 of the analysis processing server 102. The shared data information table 332 is a table for management of reference data and output data when the analysis program 306 of the analysis processing server 102 is executed in a distributed manner.

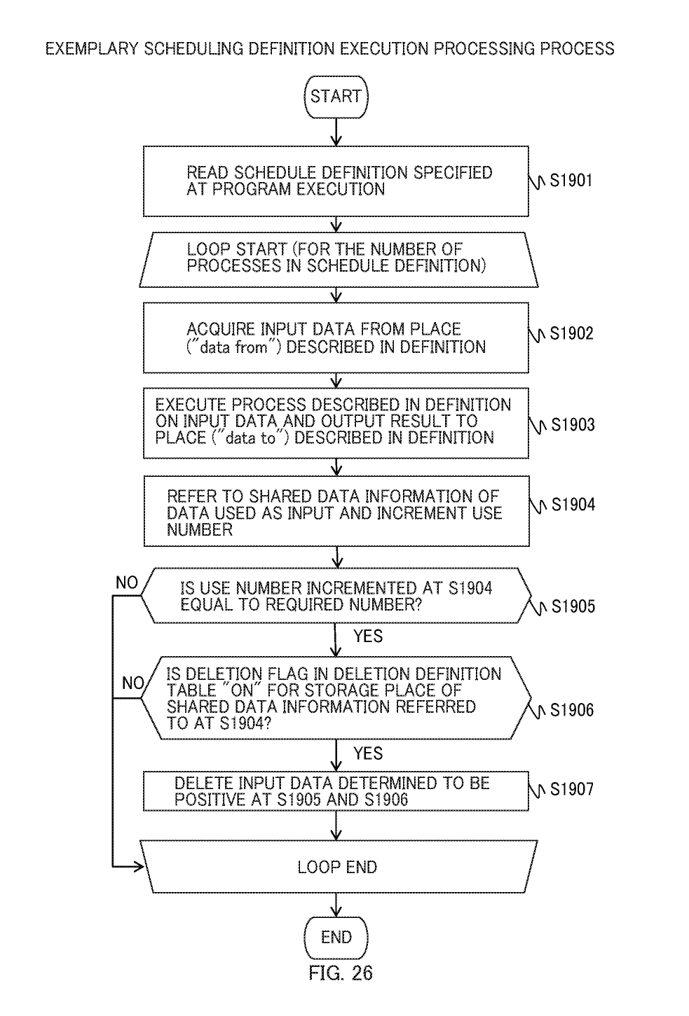

The shared data information table 332 manages the items of a data name, a storage place, a required number, and a use number for each piece of reference data and output data when the analysis program 306 is executed in a distributed manner. The data name indicates the names of data written in the input data (“essential data”), the demand input data (“demand data”), and the output data (“output data”) essential for execution of the analysis processes 311 of the analysis program 306 described in the processing model 221 illustrated in FIG. 13, in other words, data handled when the analysis program 306 is executed. The storage place indicates a place where each piece of data is stored or to be stored based on the content of description of the schedule definition 331. The required number indicates the number of times that each piece of data is referred to from each procedure described in the schedule definition 331. The use number indicates the number of pieces of data, reference to which from each procedure is ended when the analysis program 306 is executed in a distributed manner in accordance with a schedule described in the schedule definition 331. These items will be described in detail with reference to a processing sequence illustrated in FIG. 26.

### Schedule Definition Execution Processing

FIG. 26 exemplarily illustrates a flowchart when the scheduling program 307 of the analysis processing server 102 executes an analysis process in accordance with a procedure defined in the schedule definition 331. This processing process is performed at each analysis processing server 102.

First, the scheduling program 307 reads schedule definition specified when the scheduling program 307 is executed (S1901). When the read schedule definition is, for example, that illustrated in FIG. 23, a schedule specified by reference sign 331a illustrated in FIG. 23 is executed at the first analysis processing server 102, and a schedule specified by reference sign 331b illustrated in FIG. 23 is executed at the second analysis processing servers 102.

Processing steps S1902 to S1907 are repeatedly executed a number of times equal to the number of procedures in the schedule definition 331 read at S1901.

Subsequently, the scheduling program 307 acquires input data from a place (“data from”) described in the schedule definition 331 (S1902). For example, when the place described in the definition is “DB”, the scheduling program 307 issues a command to execute a DB API included in the database I/F 313 of the analysis program 306. When the place described in the definition is “KVS”, the scheduling program 307 issues a command to execute a KVS API included in the data storage server I/F 312 of the analysis program 306.

Subsequently, the scheduling program 307 executes a process described in the definition on the input data and outputs a result of the execution as output data to a place (“data to”) described in the definition (S1903). Specifically, the scheduling program 307 executes the corresponding analysis process 311 of the analysis program 306, and thereafter, similarly to the procedure at S1902, executes an API included in the data storage server I/F 312 or the database I/F 313 and outputs data.

Subsequently, the scheduling program 307 refers to the shared data information table 332, and increments the use number of data used as the input (S1904). For example, when data A is input, processing A is executed, and data processed A is output, the use number of the record of data A in the shared data information table 332 is changed from 0 to 1.

Subsequently, the scheduling program 307 determines whether the value of the use number incremented at S1904 is equal to a value defined by the required number. When it is determined that the equality is not satisfied (No at S1905), the process returns to S1902. When it is determined that the equality is satisfied (Yes at S1905), the process proceeds to processing at S1906. In the above-described example, the use number of data A is incremented from 0 to 1, so that the use number is equal to the value of 1, which is recorded in the required number, and thus the process proceeds to S1906.

At S1906, the scheduling program 307 determines whether the deletion flag in the deletion definition table 223 is “ON” for a storage place defined in the shared data information table 332 and referred to at S1904. When it is determined that the deletion flag is “OFF” instead of “ON” (No at S1906), the process returns to S1902. When it is determined that the deletion flag is “ON” (Yes at S1906), the process proceeds to S1907. In the above-described example, the storage place of data A is “DB”, and thus the record of “DB” in the deletion definition table 223 is referred to. When the deletion flag of “DB” is set to “OFF”, the process proceeds to S1902. When the deletion flag of “DB” is set to “ON”, the process proceeds to S1907.

When it is determined that the deletion flag is set to “ON” (Yes at S1906), the scheduling program 307 deletes input data determined to be positive at S1905 and S1906 (S1907). In the above-described example, data A stored in the DB is deleted.

When all contents described in the schedule definition 331 of each analysis processing server 102 has ended through the above-described procedure, it is determined that the analysis program 306 has ended. The execution of the analysis program 306 through the scheduling program 307 in this manner eliminates the need to produce a dedicated computer program configured to execute the schedule definition 331 calculated by the schedule calculation program 206, and enables execution of the analysis program 306 in a distributed manner.

### Exemplary GUI Screen of Scheduling Program 307

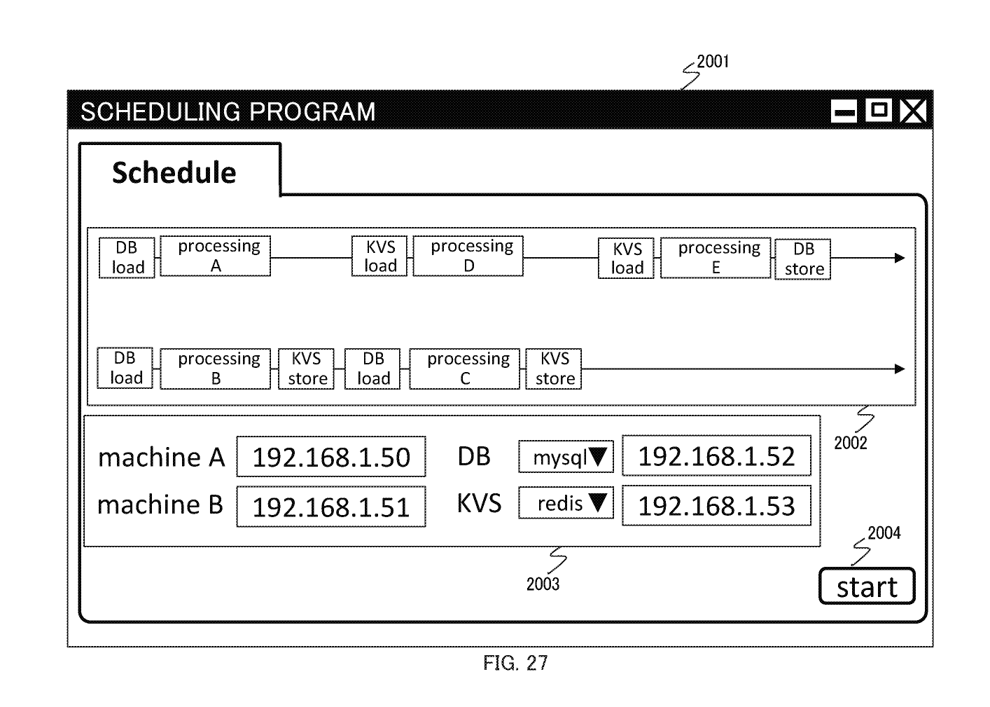

FIG. 27 is a diagram exemplarily illustrating a GUI screen when the scheduling program 307 is operational. This GUI screen 2001 includes a schedule diagram 2002 schematically presenting a schedule used to execute distributed analysis processing, an input interface 2003 through which information needed to execute the scheduling program 307 is input, and an execution button 2004 used to execute the scheduling program 307.

The schedule diagram 2002 used to execute distributed analysis processing illustrates a plurality of the schedule definitions 331 calculated by the schedule calculation program 206 in the format exemplarily illustrated in FIG. 24.

The input interface 2003 receives inputting of the IP address of a computer that executes the analysis program 306, the type and IP address of a DB referred to by the analysis program 306 when performing analysis processing, and the type and IP address of a KVS referred to by the analysis program 306 when performing analysis processing. The IP address of a computer that executes the analysis program 306 needs to be set in a number equal to the number of schedules illustrated in the schedule diagram 2002 used to execute distributed analysis processing. This number is equal to the number of the arithmetic performance definitions 222 referred to by the schedule calculation program 206 when calculating a schedule, except that the number of analysis processes is not so large as to require distributed execution, in other words, the processing model 221 has few descriptions. The type and the IP address of a DB referred to by the analysis program 306 when performing analysis processing, or the type and IP address of a KVS referred to by the analysis program 306 when performing analysis processing are items specifically indicating a DB or KVS program to be accessed when a DB or a KVS described in the schedule definition 331 is accessed. In the example illustrated in FIG. 27, there are various kinds of DB and KVS products, and thus a product is selected in the pull-down format. The products to be selected include APIs corresponding to the data storage server I/F 312 and the database I/F 313 of the analysis program 306 of the analysis processing server 102.

The scheduling program 307 can be operated by inputting all of the IP address of a computer that executes the analysis program 306, the type and IP address of a DB referred to by the analysis program 306 when performing analysis processing, and the type and IP address of a KVS referred to by the analysis program 306 when performing analysis processing on the input interface 2003, and pressing the execution button 2004.

In the above-described distributed data processing system according to the present embodiment, a computer program including a plurality of data processing processes can be efficiently processed in a distributed manner at a plurality of processors.

Since a data processing model is produced based on the property of data to be actually processed through the data processing processes, a data processing procedure preferable for efficient processing of the data processing process in a distributed manner is generated.

Since a data processing model is produced based on system requirements requested at execution of the data processing process, such as indexes of efficient arithmetic processing and efficient memory use at a processor, and weights of the system requirement indexes can be changed, distributed data processing in accordance with a desired system requirement can be achieved.

Since data used in a data processing process can be set to be deleted from the storage place thereof, efficient memory use can be achieved. Since a data processing model is produced with taken consideration the arithmetic performance of each processor, the processor can be operated more efficiently. When a produced data processing schedule is output and displayed, the data processing procedure of each data processing process can be visually understood.

Although the present disclosure has been described with reference to example embodiments, those skilled in the art will recognize that various changes and modifications may be made in form and detail without departing from the spirit and scope of the claimed subject matter.

What is claimed is:

1. A distributed data processing system configured to cause a plurality of processors to perform distributed processing of a plurality of data processing processes, the system comprising:
a data storage configured to store data to be processed through the data processing processes;
a data processing section configured to cause the data processing processes to be executed; and
a scheduler configured to produce a data processing schedule as a data processing procedure of the data processing processes to be executed by the data processing section based on a data processing model obtained by modeling the data processing procedure to be executed by the data processing section,
the data processing section causing the processors to execute the data processing processes in accordance with the data processing procedure set in the data processing schedule.

2. The distributed data processing system according to claim 1, wherein
the data processing model defines, for each data processing process,
input data necessary for the data processing process, a processing data unit as an index indicating a unit data amount to process the input data, output data to be obtained through the data processing process, an output data ratio as an index indicating a data amount ratio of the output data relative to the input data, and a process processing load as an index indicating a load on each processor processing the data processing process.

3. The distributed data processing system according to claim 1, wherein the input data, the data processing section, the output data, the output data ratio, and the process processing load defined by the data processing model are set based on processing target data to be actually processed through the data processing process.

4. The distributed data processing system according to claim 1, wherein the scheduler calculates a system requirement index as an index concerning a plurality of system requirements for each data processing process defined by the data processing model, and calculates the data processing schedule based on the system requirement indexes calculated for all combinations of the data processing processes and calculation execution units included in the processors to execute the data processing processes in accordance with the data processing model.

5. The distributed data processing system according to claim 1, wherein
the scheduler holds, based on the data processing model, the number of times to use particular data and a deletion flag indicating whether to delete the particular data after use, and
when determining that the deletion flag is set to the particular data after use of the particular data, the data processing section deletes the particular data from a storage place of the particular data.

6. The distributed data processing system according to claim 4, wherein the system requirement evaluation index includes a calculation cost as an index indicating a load required for calculation processing at each processor, or a memory cost as an index indicating a load required for processing of storing data in a memory.

7. The distributed data processing system according to claim 6, wherein the scheduler calculates the calculation cost by correcting the calculation cost based on arithmetic performance of each processor.

8. The distributed data processing system according to claim 4, wherein
the scheduler includes a plurality of the system evaluation indexes,
the system requirement indexes are weighted, and
the scheduler determines the data processing schedule in accordance with an evaluation value calculated based on the weighted system requirement indexes.

9. The distributed data processing system according to claim 1, wherein the scheduler includes an output screen on which a diagram schematically presenting the produced data processing schedule is displayed.

10. The distributed data processing system according to claim 1, wherein
the data processing model defines, for each data processing process,
input data necessary for the data processing process, a processing data unit as an index indicating a unit data amount to process the input data, output data to be obtained through the data processing process, an output data ratio as an index indicating a data amount ratio of the output data relative to the input data, and a process processing load as an index indicating a load on each processor processing the data processing process,
the input data, the processing data unit, the output data, the output data ratio, and the process processing load defined by the data processing model are set based on processing target data to be actually processed by the data processing process,
the scheduler calculates a system requirement index as an index concerning a plurality of system requirements for each data processing process defined by the data processing model, and calculates the data processing schedule based on the system requirement indexes calculated for all combinations of the data processing processes and calculation execution units included in the processors to execute the data processing processes in accordance with the data processing model,
the number of times to use particular data and a deletion flag indicating whether to delete the particular data after use are held based on the data processing model,
when determining that the deletion flag is set to the particular data after use of the particular data, the data processing section deletes the particular data from a storage place of the particular data,
the system requirement evaluation index includes a calculation cost as an index indicating a load required for calculation processing at each processor, or a memory cost as an index indicating a load required for processing of storing data in a memory,
the scheduler calculates the calculation cost by corrects the calculation cost based on arithmetic performance of each processor,
the scheduler includes a plurality of the system evaluation indexes,
the system requirement indexes are weighted,
the scheduler determines the data processing schedule in accordance with an evaluation value calculated based on the weighted system requirement indexes, and
the scheduler includes an output screen on which a diagram schematically presenting the produced data processing schedule is displayed.

11. A distributed data processing method of causing a plurality of processors to perform distributed processing of a plurality of data processing processes, the method comprising the steps of:
storing data to be processed through the data processing processes;
producing a data processing schedule as a data processing procedure of the data processing processes based on a data processing model obtained by modeling the data processing procedure of the data processing processes; and
causing the processors to execute the data processing processes in accordance with the data processing procedure set in the data processing schedule.
